(19) United States
(12) Patent Application Publication
(10) Pub. No.: US 2002/0087521 A1
(43) Pub. Date: Jul. 4, 2002

(54) Name searching

(75) Inventor: Martin Giles Lee, Oxford (GB)

Correspondence Address: ARENT FOX KINTNER PLOTKIN & KAHN, PLLC, 1050 Connecticut Avenue, N.W. Suite 600, Washington, DC, 20036-5339, US

(73) Assignee: The Naming Company Ltd.,

(21) Appl. No.: 09/748,860

(22) Filed: Dec. 28, 2000

(51) Int. Cl. G06F 7/00

(52) U.S. Cl. 707/3

(57) ABSTRACT

A method of identifying personal names in an electronic file published on the WWW 2. The method comprises downloading the file to a computer 1, and parsing the file to divide it into individual words and identifying words or word sequences which represent candidate names. For each candidate name, the word or words making up that name are compared against a database of known false positive name entities. If the candidate name contains a known false positive name entity or entities, that name is flagged as an invalid personal name. If the candidate name does not contain a known false positive name entity or entities, the candidate name is either accepted as a personal name or further processed to check its validity.

### FIELD OF THE INVENTION

The present invention relates to name searching in electronic files.

### BACKGROUND TO THE INVENTION

The increasing use of electronic documents, including web pages, especially for business and news media purposes, has lead to major problems in identifying and retrieving relevant documents. Search engines such as Altavista™, Lycos™ and others, provide full text indices of documents, where every word that occurs within a document is stored with a reference to the parent document. Users can retrieve relevant documents by searching the index to select the set of documents that contain occurrences of keywords specified by the user.

One of the many limitations of existing search engines is that a full text index does not .contain any other information about the words found on a document other than the frequency of occurrence. The system does not have any knowledge of the context of a word or of the meaning of a word: this limits the options for a user to try to reduce the number results returned for a search query.

U.S. patent Ser. No. 4,965,763 describes a process for identifying personal names located in certain portions, i.e. the beginning and end, of a text document.

### STATEMENT OF THE INVENTION

According to a first aspect of the present invention there is provided a method of identifying personal names in an electronic file, the method comprising:

(1) parsing the file to divide it into individual words;

(2) identifying words or word sequences which represent candidate names;

(3) for each candidate name,

comparing the word or words making up that name against a database of known false positive name entities and,

if the candidate name contains a known false positive name entity or entities, flagging that name as an invalid personal name and,

if the candidate name does not contain a known false positive name entity or entities, either flagging the name as a potentially valid personal name or further processing the name to check its validity.

Preferably, further processing of a candidate name comprises comparing the word or words making up the candidate name against a database of known name entities and, if the candidate name contains a known name entity or entities, that name is accepted as a personal name and, if the candidate name does not contain a known name entity or entities, the name is either flagged as an invalid personal name or further processed to check its validity.

It will be appreciated that the steps of searching databases of known false positive names and known names may be carried out sequentially or simultaneously. In the latter case, the known false positive names and known names may be incorporated into a single database. In the former case, a candidate name which does not contain a known false positive name entity or entities is further processed by carrying out said comparison against a database of known name entities.

For candidate names which are not identified as known false positive names or known names, a further check may be carried out by comparing the name or name entities against a database of common words. Names entirely composed of common words may be rejected as personal names, whilst those names not containing common words may be accepted as valid personal names.

Preferably, prior to step (1) the electronic file is divided into separately searchable word sets. This division may be made according to sentence and paragraph breaks in the file. Step (2) then comprises identifying, using a rule base, words or word sequences which represent candidate names within each word set.

The electronic file may be for example a text file (such as a .txt file) or an html file. In the later case, and for similarly structured files, the file may be pre-processed to remove mark-up tags.

According to a second aspect of the present invention there is provided a method of identifying personal names in an electronic file which can be accessed via a computer network, the method comprising:

(1) downloading the file via the network to a computer;

(2) parsing the file to divide it into individual words;

(3) identifying words or word sequences which represent candidate names;

(4) for each candidate name, comparing the word or words making up that name against a database of known false positive name entities and,

if the candidate name contains a known false positive name entity or entities, flagging that name as an invalid personal name and,

if the candidate name does not contain a known false positive name entity or entities, either flagging the name as a potentially valid personal name or further processing the name to check its validity.

Preferably, the word or words making up a candidate name are compared against a database of known name entities and, if the candidate name contains a known name entity or entities, that name is accepted as a personal name and, if the candidate name does not contain a known name entity or entities, the name is either flagged as an invalid personal name or further processed to check its validity.

According to a third aspect of the present invention there is provided a method of constructing an index of personal names linked to electronic files which include the names, the method comprising:

identifying personal names present in a plurality of electronic files using the method of the above first or second aspects of the present invention; and

storing the identified names in an electronic database, each name being linked in the database to the electronic file(s) which contain(s) the name.

According to a fourth aspect of the present invention there is provided a method of monitoring electronic files published on a network, the method comprising:

at a computer having access to the network, defining at least one address pointing to an electronic file or files the contents of which are to be monitored;

periodically downloading the file(s) over the network from said location; and

for each download, identifying a personal name or names present in said file(s) and automatically generating a report containing said name(s).

The method of the fourth aspect may comprising pre-defining at said computer one or more personal names. The downloaded files are then searched to identify the presence of said names. Alternatively, a search may be carried out for any personal names present in the files.

The present invention is applicable to local area networks (LANs) and wide area networks (WANs). However, it is particularly applicable to scanning documents published on the world wide web (WWW), in which case said address pointing to an electronic file or files is a URL. Preferably, said report contains the URL of the file containing an identified personal name and/or a file name or document title.

The report which is generated may contain, for the or each identified personal name, the number of occurrences of the name.

Said computer may download a set of files located at said pre-defined URL, for example a “home” page and pages linked to the home page.

A plurality of URLs may be defined at said computer, so that the computer searches a corresponding plurality of web sites where each site may comprise a plurality of pages (each of which is an electronic file).

According to a fifth aspect of the present invention there is provided a method of facilitating access to documents over a network, the method comprising:

searching a plurality of electronic files to identify personal names;

generating a file containing the identified names or a sub-set thereof and links to the files containing the names; and

making the generated file available for downloading over the network.

The network over which the documents are made available may be the Internet (WWW) or an intranet.

The file containing identified names and links may be a web page or a wap page, suitable for downloading to a wireless terminal.

According to a sixth aspect of the present invention there is provided an electronic news service comprising publishing on the Internet a list of personal names, said names having been identified by searching for personal names in a multiplicity of electronic files, each published name being associated with a hyperlink or hyperlinks to Internet pages containing that name.

According to a seventh aspect of the present invention there is provided a method of determining associations between personal names mentioned in a set of electronic files, the method comprising:

identifying personal names contained in a set of electronic files using the method of any one of claims 1 to 6; and

for each name identified, determining the set of names mentioned in the same document(s).

Embodiments of the present invention do not attempt to record all words that occur within a document, but only the names of individuals named within the document. The list of names mentioned may be recorded to form an index of names and documents. This index may then be searched or displayed as part of a summary of a document to a user, or used to form the basis of a browsable directory structure based around names, or may be used to calculate frequency of occurrence of individuals within a set of documents.

### BRIEF DESCRIPTION OF THE DRAWINGS

FIG. 1 illustrates a computer connected to the WWW for the purpose of identifying names in published files;

FIG. 2 is a flow diagram illustrating in general terms a method of identifying names; and

FIGS. 3 to 3F show a flow diagram illustrating in detail a method of searching for personal names in an electronic file.

### DETAILED DESCRIPTION OF A PREFERRED EMBODIMENT

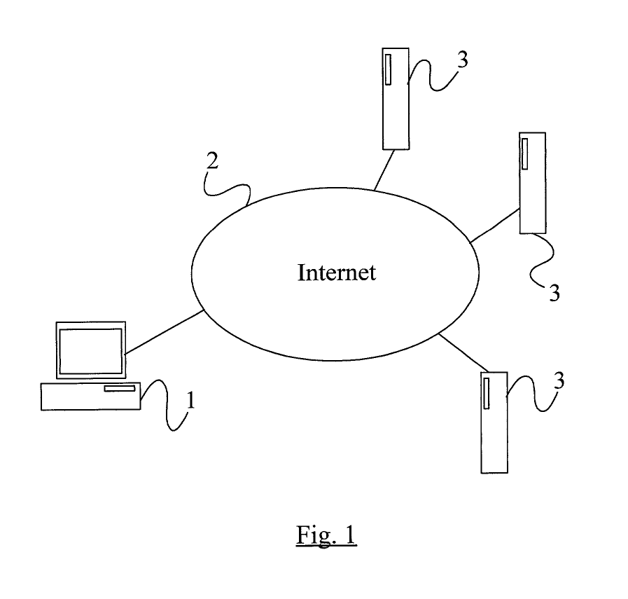

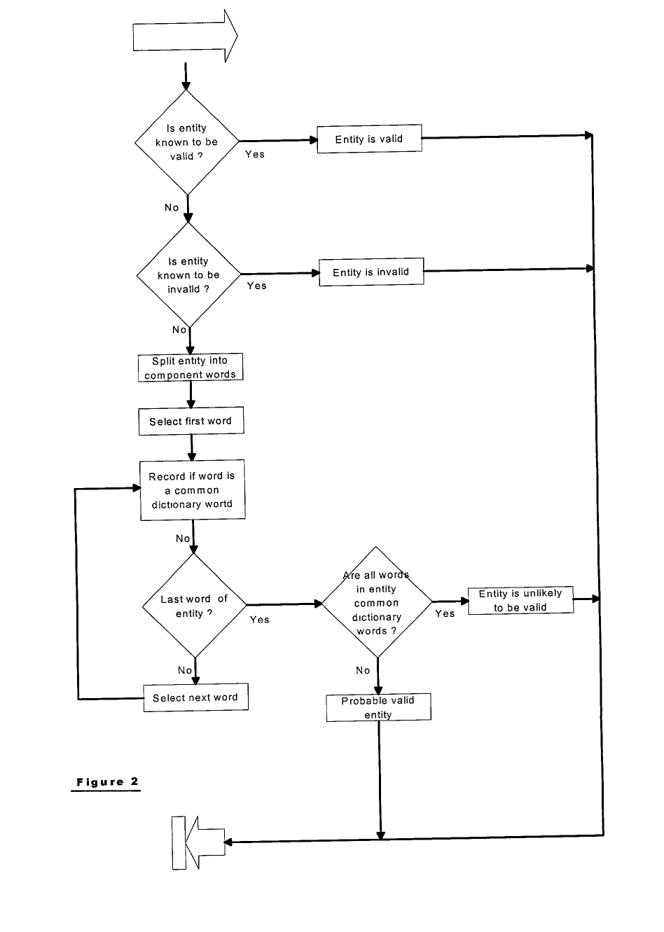

There is illustrated in FIG. 1 a computer system 1 coupled to the Internet 2. Via the Internet 2, the computer system 1 is able to connect to remote web servers 3 and to download electronic files from these servers 3. Typically, downloaded files are html files which can be displayed by a web browser running on the computer system 1. However, this need not be the case and the downloaded files may have another format (e.g. the files may be Microsoft Word™ files or pdf files).

For the purpose of the following discussion it is assumed that the computer system 1 is owned and operated by an information collection and management company which provides services to client companies. The computer system 1 is configured to download files located at a set of predefined URLs, corresponding to address locations of the web servers 3.

The computer system comprises:

a parser to parse an electronic file and identify words which are candidates for being the start of an individual's name;

a rule base for describing the order and types of words that form a name, such as “a title such as ‘Mr’ or ‘Mrs’ may be followed by a forename, which must be followed by a surname”, etc;

a database of words (name elements) and their types, such as title, forename, surname etc., which may be assembled to form an individual's name (name entity);

a database of known valid and known invalid name entities, against which candidate name entities can be validated;

a database of common dictionary words against which the elements within a name entity can be compared to judge the probable validity of the name entity;

a function to output all names discovered within a document; and

a database to record the association between a document and mentioned names.

Each electronic file downloaded over the Internet 2 is prepared for parsing. If necessary the document is changed into plain text form. The mark-up of the document is parsed to identify paragraph or line breaks and these are flagged as being the ends of any potential name entity. All mark-up related to the document's format, such as HTML tags, are removed. Any special characters, such as SGML character entities are resolved to their non-accented parent character. Characters across which a name entity cannot span, such as a colon, semi colon etc. are also flagged as the ends of any potential name entity. The document is tokenised into its component words, a word being defined as a sequence of alphabet characters, the beginning and end of a word being marked by at least one non-alphabet character.

The file is then parsed sequentially word by word. If a word has an initial capital letter, it is identified as a candidate for being the start of a name entity, otherwise the word is skipped.

The case of a candidate name element forming part of a name entity is normalised, the first letter set to upper case, all other letters set to lower case. The database is queried to identify the possible types of name elements the word may be, i.e. title, forename, initial, linker or surname. A linker is a name element such as ‘O’,‘van’,‘von’,‘mac’,‘de’ etc. If the word is not a name element, or a name element of type linker or surname, the name element cannot form part of a valid name entity, the attempt to form a name entity fails, and the word skipped. Otherwise a putative name entity is created with the identified name element as the initial element of the entity. The following words are examined if they are name elements, and if their sequence is a pattern that may constitutes a valid name entity.

The rules that define a valid name entity are:

the first name entity must be a title, a forename or an initial;

the only name elements that may occur before a forename is a title or one initial;

there may be up to three forenames;

after the forename or forenames there may be up to three initials;

up to three initials may occur in the absence of any forenames;

a name entity can consist of a maximum of three forenames and initials;

after the initials or forenames there may be up to three linkers;

after the linkers there may be up to two surnames;

the last name element of a name entity must be a surname;

titles, forenames, surnames must have their first character in upper case;

linkers may be entirely lower case; and

one initial is defined as a word consisting of one or two letters, all of which must be in upper case.

A name entity identified by these rules can be displayed or recorded as such, or further processing may take place to reject sequences of words that have been falsely identified as valid name entities. The further processing comprises:

Comparing the name entity against a database of known invalid name entities. This database is typically constructed manually by searching for names in a large number of sample documents, and adding identified but invalid “names” to the database. If the name entity is known to be invalid, it is rejected.

Candidate names not rejected are compared against entries in a database of known personal names (the database may be compiled using for example one or a series of telephone directories). If the name entity is known to be valid it may be displayed or recorded as such.

Otherwise, each element of the name entity is compared against a database of common words. If all the elements of a name entity are found within the database of common words, then the entity is unlikely to be valid, and may be recorded or displayed as such. The composition of the database of common words may be varied according to the language or context of the document being indexed. The definition of common may be varied according to the relative precision required by the application. Raising the level of frequency at which words are defined as being common, to exclude words from the database of common words will tend to reduce the number of entities identified as being unlikely, decreasing the level will have the opposite effect.

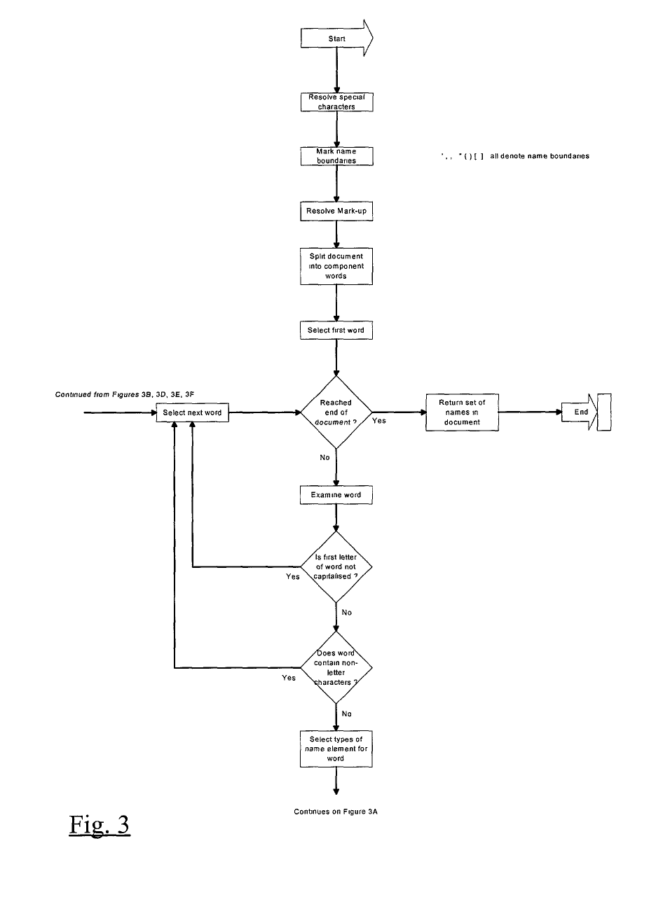

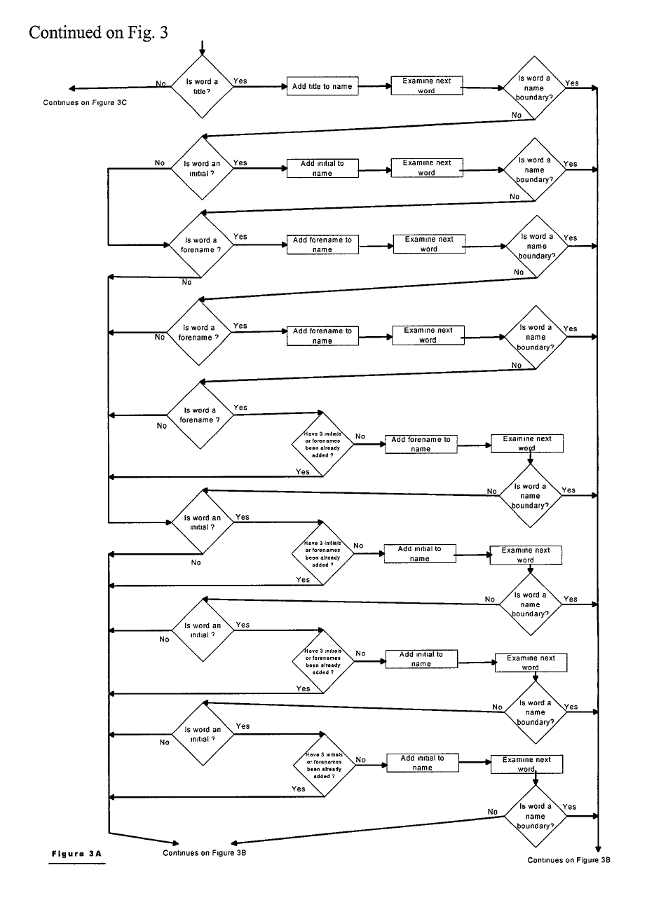

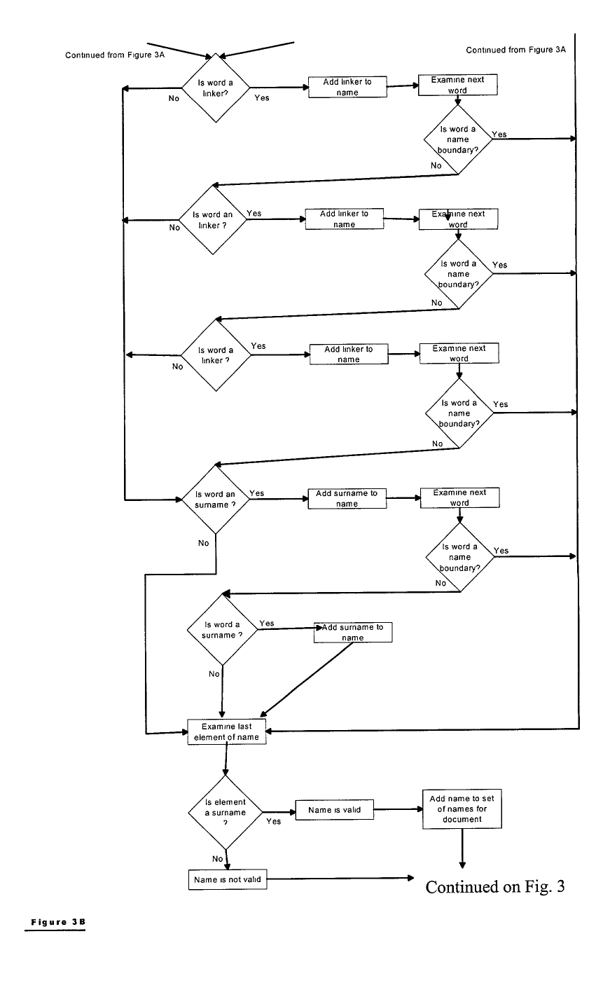

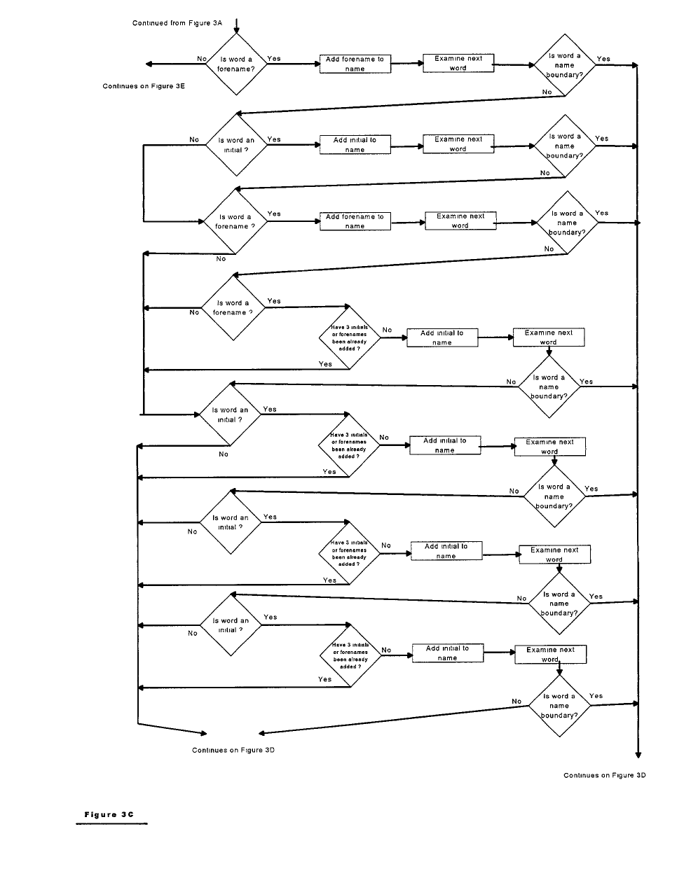

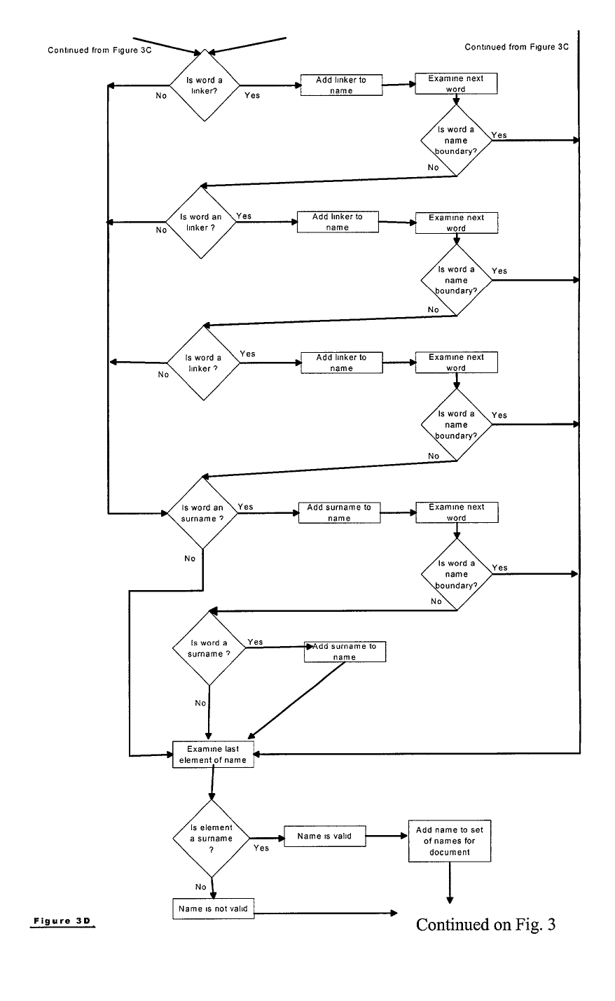

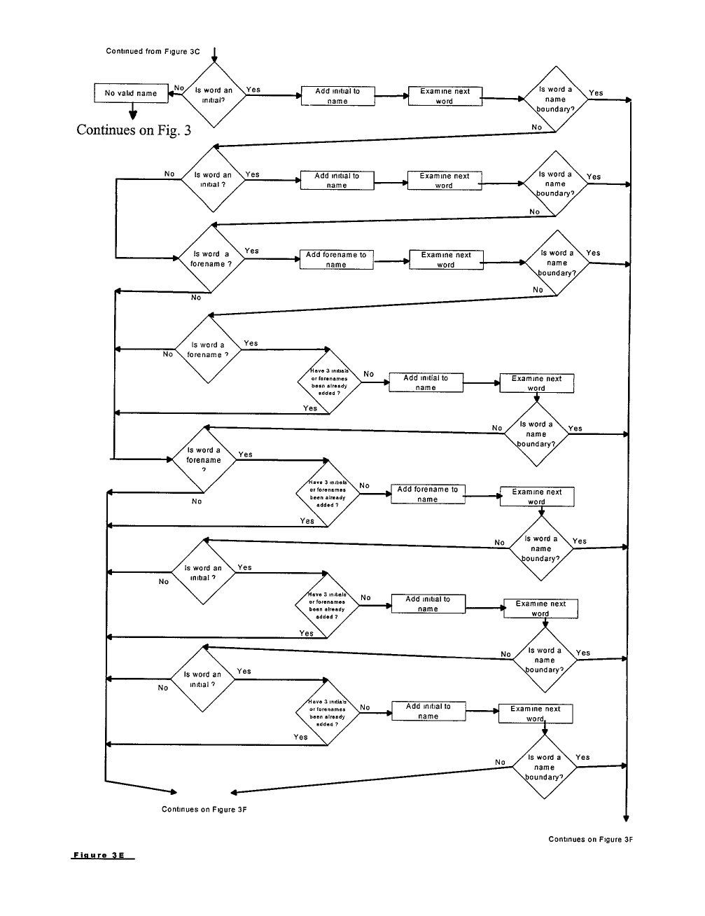

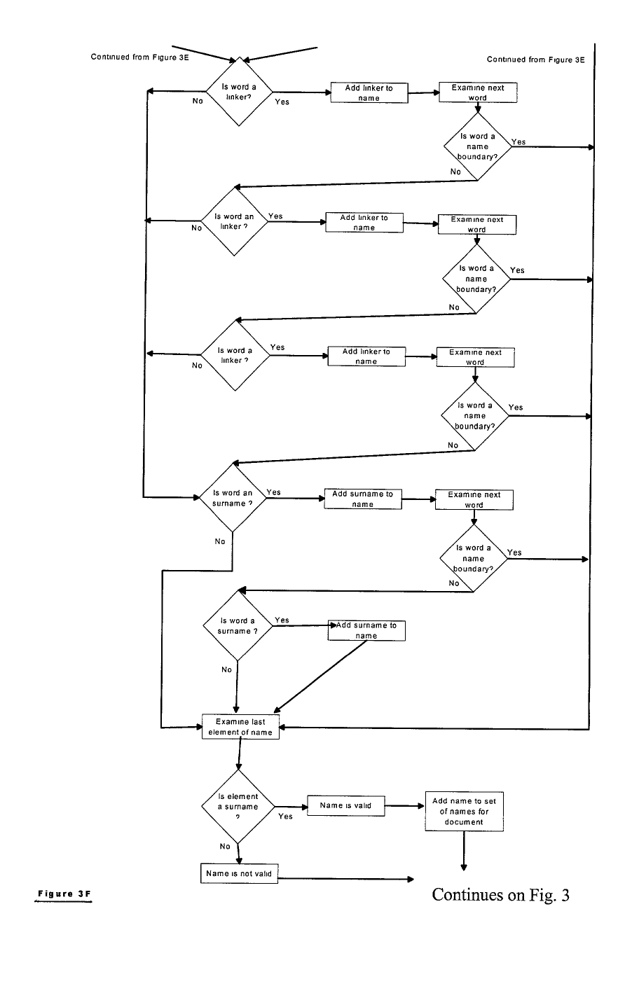

FIG. 2 illustrates the name searching method in general terms, whilst the flow diagram of FIGS. 3 to 3F illustrate the method in more detail.

The information which is produced by this method may be made available via the Internet as a published web page or wap page. Users may subscribe to a service of the company operating the computer system 1 in order to enable them to access the web or wap page. In some scenarios, an operator may “push” a wap or web page to a subscriber, the pushed page containing the identified names together with hyper to the web pages containing these names links

It will be appreciated by the person of skill in the art that various modifications may be made to the above described embodiment without departing from the scope of the present invention. For example, a system may be implemented using the present invention to identify personal names in documents and to create associations between names based upon the occurrence of different names in the same documents. Using the results of such a search, a user may identify a set of names which are associated with a specific name presented by the user. A system may also be implemented which identifies the frequency with which individuals are named in one or a set of documents. The results may be presented as an ordered list of names, e.g. with the most frequently mentioned name appearing first. It will be appreciated that the present invention may be used to search documents available on any type of computer system or computer network, and is not limited to use with the Internet (WWW).

1. A method of identifying personal names in an electronic file, the method comprising:
(1) parsing the file to divide it into individual words;
(2) identifying words or word sequences which represent candidate names;
(4) for each candidate name,
comparing the word or words making up that name against a database of known false positive name entities and,
if the candidate name contains a known false positive name entity or entities, flagging that name as an invalid personal name and,
if the candidate name does not contain a known false positive name entity or entities, either flagging the name as a potentially valid personal name or further processing the name to check its validity.

2. A method according to claim 1 and comprising, prior to step (1), dividing the electronic file into separately searchable word sets according to sentence and paragraph breaks in the file and identifying words or word sequences which represent candidate names within each word set.

3. A method according to claim 1 or 2, wherein the electronic file contains mark-up tags, and the file is pre-processed to remove these mark-up tags.

4. A method of identifying personal names in an electronic file which can be accessed via a computer network, the method comprising:
(1) downloading the file via the network to a computer;
(2) parsing the file to divide it into individual words;
(3) identifying words or word sequences which represent candidate names;
(4) for each candidate name, comparing the word or words making up that name against a database of known false positive name entities and,
if the candidate name contains a known false positive name entity or entities, flagging that name as an invalid personal name and,
if the candidate name does not contain a known false positive name entity or entities, either flagging the name as a potentially valid personal name or further processing the name to check its validity.

5. A method according to claim 1 or 4, wherein further processing of a candidate name comprises comparing the word or words making up a candidate name against a database of known name entities and, if the candidate name contains a known name entity or entities, that name is accepted as a personal name and, if the candidate name does not contain a known name entity or entities, the name is either flagged as an invalid personal name or further processed to check its validity.

6. A method according to claim 1 or 4 and comprising, for candidate names which are not identified as known false positive names or known names, carrying out a further check by comparing the name or name entities against a database of common words, wherein names entirely composed of common words are rejected as personal names, whilst those names not containing common words are accepted as valid personal names.

7. A method of constructing an index of personal names linked to electronic files which include the names, the method comprising:
identifying personal names present in a plurality of electronic files using the method of any one of the preceding claims; and
storing the identified names in an electronic database, each name being linked in the database to the electronic file(s) which contain(s) the name.

8. A method of monitoring electronic files published on a network, the method comprising:
at a computer having access to the network, defining at least one address pointing to an electronic file or files the contents of which are to be monitored;
periodically downloading the file(s) over the network from said location; and
for each download, identifying a personal name or names present in said file(s) and automatically generating a report containing said name(s).

9. A method according to claim 8 and comprising pre-defining at said computer one or more personal names and searching the downloaded files to identify the presence of said names.

10. A method according to claim 8 or 9, wherein said network is the WWW and said address is a URL, the report containing the URL of the file containing an identified personal name and/or a file name or document title.

11. A method according to claim 8, the report containing for the or each identified personal name, the number of occurrences of the name.

12. A method according to claim 8, wherein said computer downloads a set of files located at said pre-defined address.

13. A method according to claim 8, wherein a plurality of addresses are defined at said computer, so that the computer searches a corresponding plurality of network sites where each site may comprise a plurality of pages.

14. A method of facilitating access to documents over a network, the method comprising:
searching a plurality of electronic files to identify personal names;
generating a file containing the identified names or a sub-set thereof and links to the files containing the names; and
making the generated file available for downloading over the network.

15. A method according to claim 14, wherein said links are hyperlinks to a web page or a wap page.

16. An electronic news service comprising publishing on the Internet a list of personal names, said names having been identified by searching for personal names in a multiplicity of electronic files, each published name being associated with a hyperlink or hyperlinks to Internet pages containing that name.

17. A method of determining associations between personal names mentioned in a set of electronic files, the method comprising:
identifying personal names contained in a set of electronic files using the method of claim 1 or 4; and
for each name identified, determining the set of names mentioned in the same document(s).
